(19) United States
(12) Patent Application Publication
(10) Pub. No.: US 2005/0008736 A1
(43) Pub. Date: Jan. 13, 2005

(54) Non-fluorocarbon high temperature packaging having flexible starch-based film and methods of producing same

(76) Inventors: Philip A. Egan, Louisa, VA (US); Stuart R. Sharp, Greer, SC (US)

Correspondence Address: BRACEWELL & PATTERSON, LLP;IP DOCKETING, P.O. BOX 61389, HOUSTON, TX, 77208-1389, US

(21) Appl. No.: 10/843,760

(22) Filed: May 12, 2004

Related U.S. Application Data
(60) Provisional application No. 60/471,607, filed on May 19, 2003.

(51) Int. Cl. A23B 4/00

(52) U.S. Cl. 426/107

(57) ABSTRACT

A non-fluorocarbon oil and grease barrier packaging for storing materials, particularly products that need oil and grease resistant characteristics and are used in high temperature applications. The barrier packaging does not contain fluorocarbons, which improves the environmental rating of the oil and grease barrier packaging. The packaging is made by applying a starch based coating having a solids content in a range about 10% to about 35% to a substrate and forming the package from the substrate. The starch based coating preferably contains a starch derivative, a flexibility enhancing agent, a rheological agent, and a scorch resistant agent. When the package is heated, no fluorocarbons are emitted as result of heating the package.

### RELATED APPLICATIONS

This application claims the benefit under 35 U.S.C. § 119(e) of U.S. Provisional Application Ser. No. 60/471,607, filed May 19, 2003, titled “Non-Fluorocarbon High Temperature Packaging Having Flexible Starch-Based Film and Method of Producing Same,” which is incorporated by reference in its entirety.

### BACKGROUND OF THE INVENTION

1. Field of the Invention

The invention relates to methods for applying oil and grease resistant coatings to packaging that can be used in high temperature applications and to the resulting packaging end product.

2. Description of Related Art

Consumer products are packaged in numerous manners to make use of the products contained within packaging more convenient for consumers. The more convenient it is for a consumer to use a product, the more likely the consumer will use the product. In addition to being convenient, the packaging must be capable of keeping the products contained within fresh and appealing. The package outside must also be aesthetically appealing. Often, to get the best protection for the goods within the packaging, the outer packaging quality has been sacrificed.

Packaging can be coated with various materials to increase certain properties of the packaging. This is particularly true when the product contained within is oily or greasy. For aesthetic reasons, for example, a paper substrate should be resistant to oil and grease stains and “stain proof” from both inside and outside of the package. Stain resistant materials can either be provided by the presence of a physical barrier or an oil and grease repellent material, e.g., fluorocarbons. Where only a repellent material is used, the oil and grease can pass or bleed through a fiber matrix within the substrate without showing a stain on the package, but staining of surfaces outside of a package can occur. If a physical barrier also is used, however, staining of external package surfaces are generally prevented. This stain proof requirement exists in manufacturing, packing, shipping and handling environments. Many times the stain proof substrate is the outer print ply of the packaging.

For years, most oil and grease resistant coatings contained chemicals known as fluorocarbons. These fluorocarbon-based coatings often are saturants applied by paper machines. An example of this type of coating having some fluorocarbon content is described in U.S. Pat. No. 5,674,961 by Fitzgerald titled “Oil Water And Solvent Resistant Paper By Treatment With Fluorochemical Copolymers” (“the '961 patent”). Synthetic fluorocarbons, however, have recently come under governmental and environmental group scrutiny due to their alleged potential deleterious environmental effects.

Prior attempts have been made to decrease the environmental effects of fluorocarbons. Alternative synthetic fluorocarbon paper treatments with more environmentally friendly characteristics have been developed. Problems still exist with these alternatives, however. For example, many of the alternatives such as described in the '961 patent still contain fluorocarbon content. Additionally, these fluorocarbon alternatives can be expensive to produce, and it is uncertain if a reliable supply source exists for the future.

One example of an attempt for more environmentally friendly oil and grease resistant compound is described in U.S. Pat. No. 4,097,297 by Keene titled “Barrier Coatings” (“the '297 patent”). The '297 patent describes an overprint varnish that is nitrocellulose based. Applicants have recognized, however, that problems still exist with these alternatives. The overprint varnish, for example, still contains fluorocarbons in a small percentage in its composition. This overprint varnish works better when used in a solution containing a solvent. The use of a solvent, however, adds considerable costs to the manufacturing process and the solvents may emit harmful volatile organic chemicals “VOC's” during application. Additionally, the method of drying the overprint varnish to substrates is inefficient and time-consuming. The drying process requires drying either with a heater, which increases capital costs, or at room temperature, which increases the time required to dry the overprint varnish.

It has been suggested that other natural compounds, such as starch compounds, can be used as extenders or additives in oil and grease resistant coatings to reduce the level of fluorocarbons required in the coating for packaging. Examples of such starch-based materials can be found in U.S. Pat. No. 6,528,088 titled “Highly Flexible Starch-Based Films” (“the '088 patent”) and U.S. Pat. No. 6,375,981 titled “Modified Starch As A Replacement For Gelatin In Soft Gel Films And Capsules” (“the '981 patent”), both by Gillenland et al. The performance of these materials for packaging applications, however, has been marginal. Applicants have recognized that these starch-based materials are too brittle for use as a fluorocarbon extender in forming primary oil and grease resistant compounds for many packaging material applications because the coating and packaging would be inflexible and would tend to crack or crease when shaped or formed. Additionally, because such fluorocarbon extender coatings tend to have relatively high viscosity, using such starch-based derivatives as an extender coating can cause difficulties when the coating is used in various paper-related packaging applications. For example, the typical conventional printing machinery that is used to apply the starch materials to the substrates cannot handle certain amounts of gel in the packaging materials. Gel formation is necessary, however, in the previously proposed fluorocarbon extender starch-based compounds to achieve the level of solids concentration required for sufficient oil and grease resistance properties. Because of the level of gel formation, the printing machinery cannot handle the high solids concentration within the starch material, and unsightly bubbles can form in the coating. As a result of these problems recognized by Applicants, the proposed use of starch-based compounds as extenders to reduce the level of fluorocarbons required in the coating is limited. Additionally, the environmental concerns inherent with the presence of fluorocarbons still remain when the starch-based compound is used as an extender.

In addition to the oil and grease resistance requirements, Applicants have recognized previously proposed fluorocarbon-extender alternative starch-containing packaging treatment materials have not shown other additional features that are sometimes desired in packaging, such as the capability for use in high temperature applications like microwave popcorn bags, microwavable food wrappers, and the like. U.S. Pat. No. 5,488,220 by Freerks et al. titled “Bag For Microwave Cooking,” U.S. Pat. No. 5,038,009 by Babbitt titled “Printed Microwave Susceptor And Packaging Containing The Susceptor,” and U.S. Pat. No. 5,171,594 by Babbitt titled “Microwave Food Package With Printed-On Susceptor” all contain examples of packaging that is used in high temperature applications, specifically microwave oven applications. Previously proposed fluorocarbon-alternative starch-containing packaging treatment materials, however, have shown minimal scorch resistance and tended to turn brown at higher temperatures.

Various other non-fluorocarbon alternatives have been developed to combat the environmental and other consequences of using fluorocarbons. Such developments include synthetic latexes, a combination of natural cellulosic gums, starch, and/or proteins, and heavy paper refining. Although these alternatives may be more environmentally friendly than fluorocarbons, there are still problems using these alternatives. The use of synthetic latexes or the combination of natural cellulosic gums, starch, and/or proteins requires very high coat weights when applying them to the paper substrates. The high coat weights result in poor paper machinery operation and increase the amount of maintenance required on these machines. Each of the alternatives is very costly, which makes them economically infeasible. Additionally, none of the three alternatives provide very good oil and grease resistance.

As another alternative to fluorocarbon components, plastic and polymer alternative packaging constructions have been developed. Applicants have recognized that problems also exist with these alternatives, however. The plastic and polymer packaging materials have very high raw material costs associated with them. These alternatives also operate less efficient on the converting and packing machinery. Additional equipment is also necessary when using these alternatives. This increases the capital assets that are required, which many times makes use of these alternatives economically infeasible.

Most packaging producers purchase paper substrates that are pretreated with oil and grease resistant materials, such as those described above. The packaging producers apply their graphics to the pretreated substrates, apply an overprint varnish over the graphics, and then form their end packaging products. This increases the raw material costs for these producers, since oil and grease resistant coatings increase the cost of the paper substrates.

With more and more products being packaged for consumer convenience, Applicants have recognized a need still exists for packaging that is environmentally friendly and provides superior barrier properties to oil and grease. With increased market competition, the packaging preferably needs to be able to be decorated aesthetically and possess enough strength to withstand the elements to which the packaging will be exposed. Applicants have also recognized a further need for a type of packaging that can provide needed oil and grease resistant properties, along with being able to perform well in high temperature applications and be sufficiently scorch resistant. Applicants have recognized yet a further need for a type of packaging that is sufficiently flexible and uses a coating that has a relatively low viscosity so that the coating can be effectively applied to various packaging substrates such as paper.

### SUMMARY OF THE INVENTION

With the foregoing in mind, embodiments of the present invention advantageously provide a method for forming a non-fluorocarbon treated high temperature package having oil and grease resistant properties and related high temperature packages Embodiments of the present invention also advantageously provide a non-fluorocarbon treated high temperature package that has oil and grease resistant properties and is environmentally friendly and relatively economical to produce. Also, the package and method according to the embodiments of the present invention advantageously provide a package with coating that gives increased flexibility and resistance to cracking to the packaging material. The package and method according to the embodiments of the present invention additionally provide a package with a coating that is advantageously lower in viscosity, which increases compatibility with typical paper making equipment. Also, the package and method according to the present invention further provide a package with a coating that is advantageously resistant to browning and scorching at increased temperatures.

More particularly, a method of forming a non-fluorocarbon treated high temperature package having oil and grease resistant properties is provided according to embodiments of the present invention and includes supplying at least one outer substrate including a paper material having a grease resistant coating devoid of fluorocarbons thereon. The coating includes a starch-based film having a pre-selected percent by weight of at least one pre-selected starch derivative, a flexibility enhancing agent, a rheological agent, and a scorch resistant agent. The at least one starch derivative includes a chemically modified starch. The method also includes supplying at least one inner substrate including having a paper material also having the grease resistant coating thereon and printing indicia on an outer surface of the at least one outer substrate. The method additionally includes laminating the at least one outer substrate having indicia thereon to the at least one inner substrate to define a laminated substance. The laminated substrate is shaped to define a front panel, a back panel opposing the front panel, and a pair of opposing side panels each extending between the front panel and the back panel. The pair of opposing side panels each has a longitudinal accordion pleat therein defining longitudinal gusseted folds in the panels. The pair of gusseted side panels are expandable about folds therein during cooking of food in the package to enlarge an interior volume of the package.

According to another aspect of the present invention, the method can also include having the coating on the outer substrate positioned on the outer surface of the outer substrate and the inner surface of the outer substrate and the coating on the inner substrate positioned on the outer surface of the inner substrate and on the inner surface of the inner substrate. The method can also include supplying a high temperature susceptor, supplying a susceptor adhesive to the inner surface of the outer substrate, and positioning the high temperature susceptor to the susceptor adhesive. The laminating step can include applying a laminating adhesive to the susceptor and to the inner surface of the outer substrate and positioning the outer surface of the inner substrate on the laminating adhesive to thereby further define the laminated substrate.

Alternatively, the grease resistant coating on the outer substrate can be positioned on the outer surface of the outer substrate, and the coating on the inner substrate can be positioned on the inner surface of the inner substrate. The laminating step then can include applying a grease resistant laminating adhesive to an inner surface of the outer substrate and positioning an outer surface of the inner substrate on the grease resistance laminating adhesive to thereby further define the laminated substrate.

For example, the grease resistant coating on the at least one of the substrates can be supplied in a composition having a solids concentration by weight of about 10% to about 35% and preferably substantially free from a gel formation. The coating preferably has a viscosity in a range of about 65 centipoises to about 156 centipoises, and the solids concentration by weight, even more preferably, is in a range of about 20% to about 25%.

Another method according to an embodiment of the present invention of forming a non-fluorocarbon treated high temperature package having oil and grease resistant properties and having contents therein preferably includes supplying at least one outer substrate including a paper material having a grease resistant coating devoid of fluorocarbons thereon. The coating includes a starch-based derivative, a flexibility enhancing agent, and a rheological agent. At least one inner substrate is supplied including a paper material also having the coating thereon. The at least one outer substrate is laminated to the at least one inner substrate to define a laminated substrate. The laminated substrate is shaped to define a preselected package shape.

An embodiment of the present invention also provides a non-fluorocarbon treated high temperature package having oil and grease resistant properties and includes at least one substrate having a paper material. The substrate defining a front panel, a back panel opposing the front panel, a bottom panel, and a pair of opposing side panels each extending between the front panel and the back panel. The pair of opposing side panels each has a longitudinal accordion pleat therein defining longitudinal gusseted folds in the panels. The pair of gusseted side panels are expandable about folds therein during cooking of food in the package to enlarge an interior volume of the package. The front panel, the back panel, and the bottom panel form a tube body. A coating is applied onto both an inner surface and an outer surface of the tube body. The coating has a starch-based film having a pre-selected percent by weight of at least one pre-selected starch derivative, a flexibility enhancing agent, and a rheological agent. The at least one starch derivative can include a chemically modified starch, and the coating further can have a scorch resistant agent associated therewith.

An additional embodiment of non-fluorocarbon treated high temperature package according to the present invention is provided having oil and grease resistant properties and includes at least one outer substrate having an inner surface and an outer surface formed of a paper material, and at least one inner substrate also formed of a paper material and having an outer surface thereof laminated to the inner surface of the outer substrate so that the combination of the at least one outer substrate and the at least one inner substrate define a laminated substrate. The laminated substrate further has a front panel, a back panel opposing the front panel, a bottom panel, and a pair of opposing side panels, each extending between the front panel and the back panel. The pair of opposing side panels each has a longitudinal accordion pleat therein defining longitudinal gusseted folds in the panels. The pair of gusseted side panels are expandable about folds therein during cooking of food in the package to enlarge an interior volume of the package. The front panel, the back panel, and the bottom panel form a tube body. A coating is positioned on both an inner surface and an outer surface of the tube body. The coating includes a starch-based film having a pre-selected percent by weight of at least one pre-selected starch derivative, including a chemically modified starch, a flexibility enhancing agent, a rheological agent and a scorch resistant agent.

Embodiments of the non-fluorocarbon treated high temperature package and methods for forming a non-fluorocarbon treated high temperature package that have oil and grease resistant properties and are devoid of fluorocarbons advantageously have significantly reduced brittleness, significantly increased flexibility, and increased resistance to oil and grease staining due to reduced cracking in or around folds in a package substrate. Because an embodiment of a starch-based derivative coating is used for a package of the present invention, the coating advantageously can be used with conventional paper making equipment to form substrates of paper material to enhance the forming of high temperature packaging. Also, in addition to being devoid or substantially devoid fluorocarbons, the high temperature package and methods according to embodiments of the present invention have enhanced scorch resistance properties.

### BRIEF DESCRIPTION OF THE DRAWINGS

Some of the objects and advantages of the present invention having been stated, others will become apparent as the description proceeds when taken in conjunction with the accompanying drawings, in which:

FIG. 1 is a perspective view of a high temperature package expanded with food contained therein and having portions thereof broken away for clarity in accordance with an embodiment of the present invention;

FIG. 2A is an enlarged fragmentary sectional view of a bag with susceptors therein taken along the line 2-2 of FIG. 1 in accordance with another embodiment of the present invention;

FIG. 2B is an enlarged fragmentary sectional view of a bag without susceptors therein taken along the line 2-2 of FIG. 1 in accordance with another embodiment of the present invention;

FIG. 2C is an enlarged fragmentary sectional view of a bag without susceptors and with a grease resistant laminating material taken along the line 2-2 of FIG. 1 in accordance with still another embodiment of the present invention;

FIG. 2D is an enlarged fragmentary sectional view of a bag without susceptors and with adhesive coating taken along the line 2-2 of FIG. 1 in accordance with yet another embodiment of the present invention;

FIG. 3 is a perspective view of an apparatus for forming a high temperature bag in accordance with an embodiment of the present invention;

FIG. 4 is a perspective view of a laminated substrate to be shaped to form a high temperature bag in accordance with an embodiment of the present invention;

FIG. 5 is a perspective view of a laminated substrate of FIG. 4 further being shaped to form a high temperature bag in accordance with an embodiment of the present invention;

FIG. 6 is a perspective view of a high temperature bag of FIGS. 4 and 5 after being substantially shaped in accordance with an embodiment of the present invention;

FIG. 7 is a simplified block diagram of a method of forming a high temperature bag in accordance with an embodiment of the present invention;

FIG. 8 is a table illustrating the effect of increasing a total amount of solids in a starch-based coating material on the elasticity of the coating, which is indicated by an increase in the viscosity of the starch solution, in accordance with an embodiment of the present invention;

FIG. 9 is a graph of the percent of solids versus the viscosity from the table of FIG. 8 illustrating the effect on the elasticity of a starch-based coating, which is shown by an increase in viscosity, with an increase in a total amount of solids in the starch material in accordance with an embodiment of the present invention;

FIG. 10 is a table illustrating the results from felt tests indicating the effect of percent total solids on the flexibility of a starch material in accordance with an embodiment of the present invention;

FIG. 11 is a graph of percent failure versus time illustrating the results of a flat felt test for a coating as a percent of failure versus time for four different total solids concentrations within the coating in accordance with an embodiment of the present invention;

FIG. 12 is a graph of percent failure versus time illustrating the results of a creased felt test for a coating as a percent of failure versus time for four different total solids concentrations within the coating in accordance with an embodiment of the present invention;

FIG. 13 is a graph of percent failure versus time illustrating the results of a creased felt test for various coatings having a starch-based derivative with a total solids concentration of 21.1% as a percent of failure versus time for four various coatings in accordance with an embodiment of the present invention;

FIG. 14 is a graph of percent failure versus time illustrating the results of a creased felt test for various coatings having a starch-based derivative with a total solids concentration of 10.5% as a percent of failure versus time for four various coatings in accordance with an embodiment of the present invention;

FIG. 15 is a graph of percent failure versus time illustrating the results of a creased felt test for various coatings having a starch-based derivative with a total solids concentration of 6.57% as a percent of failure versus time for four various coatings in accordance with an embodiment of the present invention;

FIG. 16 is a table illustrating examples of results from scorch resistance tests for various coatings on two different grades of packaging paper in accordance with an embodiment of the present invention; and

FIG. 17 is a pair of bar graphs showing identification number versus scorch resistance ranking for two particular grades of packaging paper, i.e., 21 pounds (#) popcorn grade and 25 pounds (#) popcorn grade, containing a coating in accordance with an embodiment of the present invention.

### DETAILED DESCRIPTION

The present invention now will be described more fully hereinafter with reference to the accompanying drawings in which illustrated embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

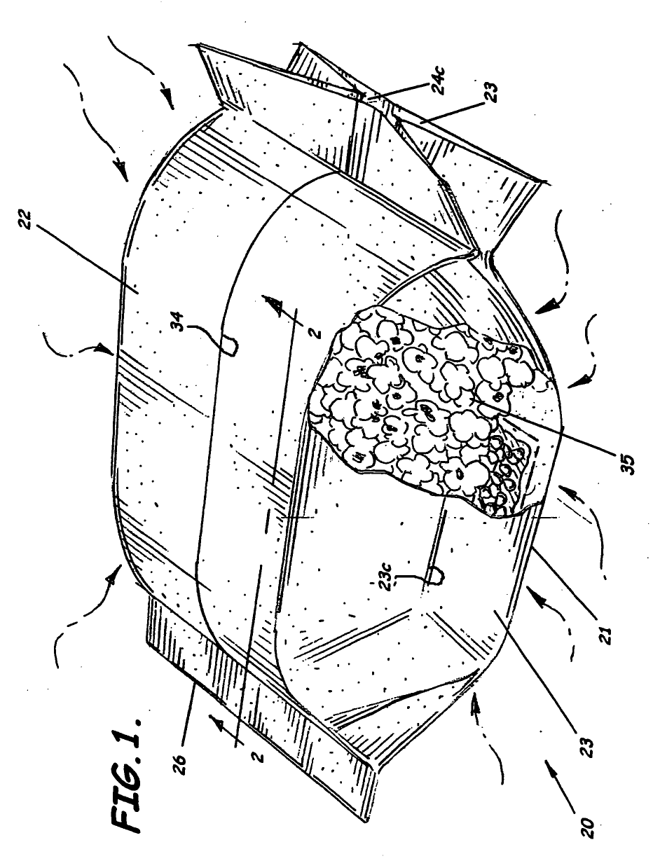

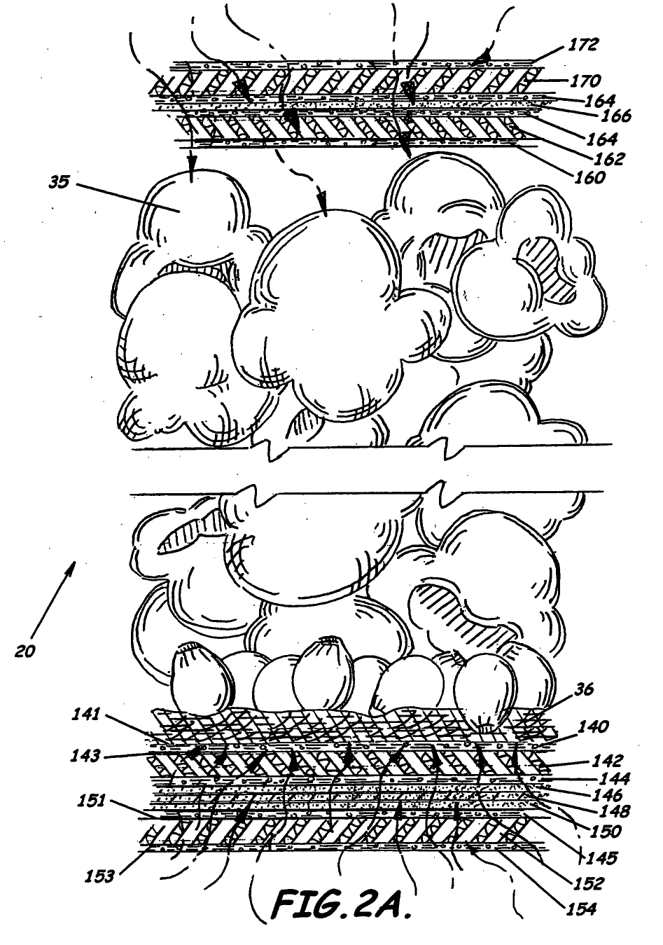

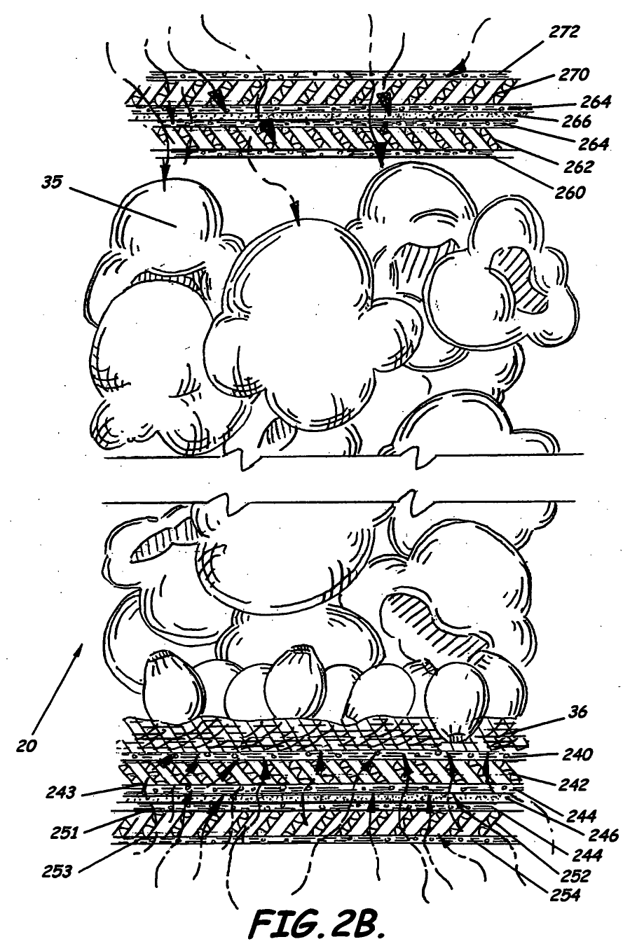

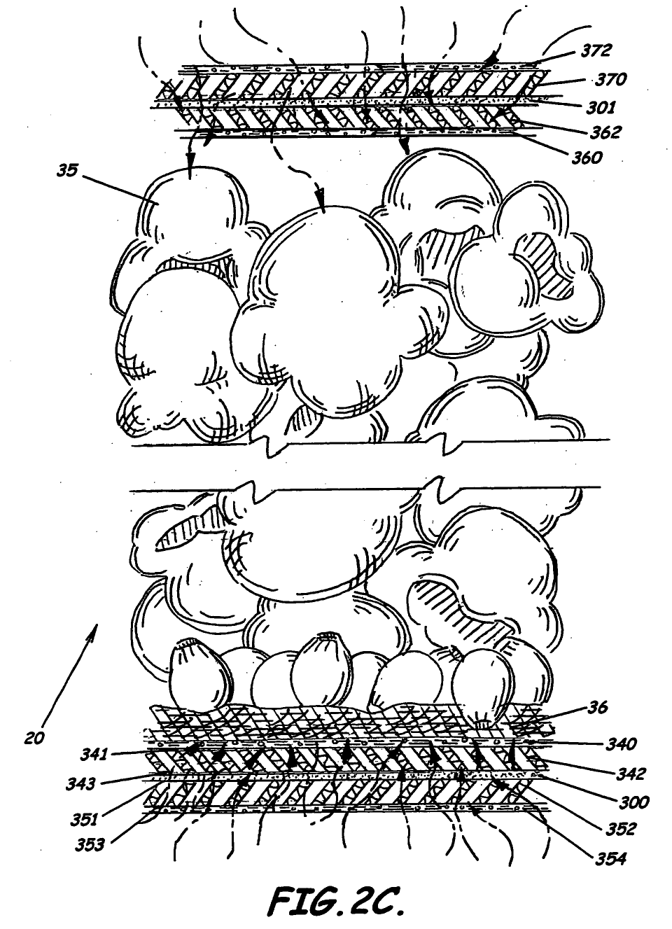

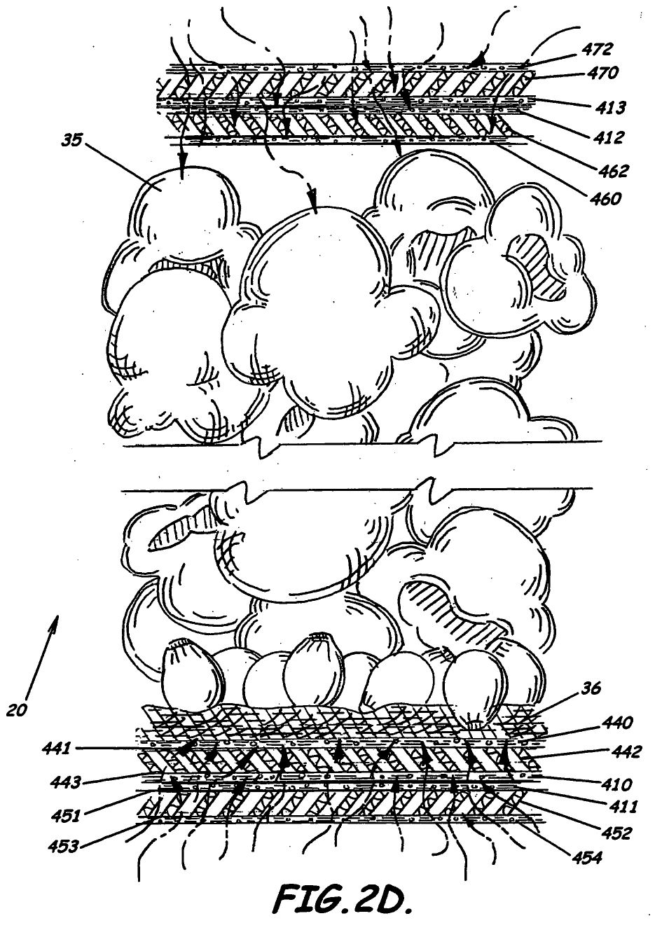

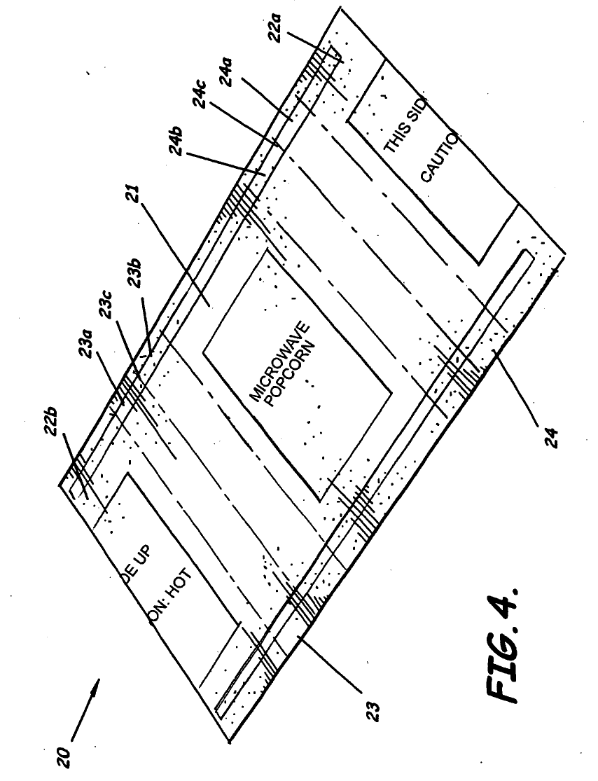

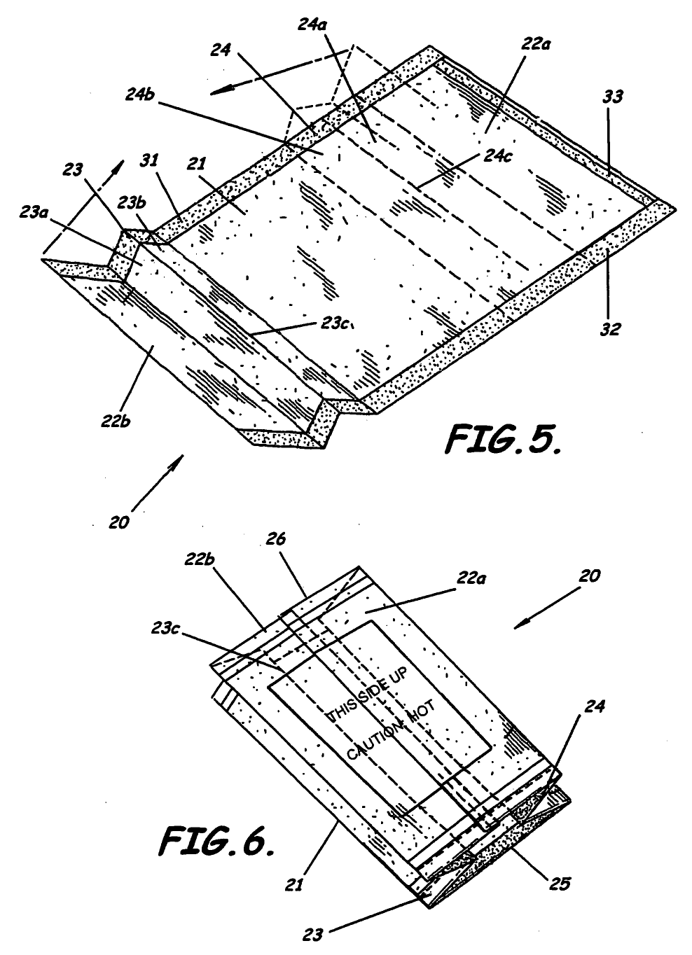

FIGS. 1 and 2A illustrate a perspective view of a non-fluorocarbon treated high temperature package 20 having oil and grease resistant properties, being devoid of fluorocarbons, and being expanded during cooking, and having food 35 contained therein. Being “devoid of fluorocarbons” as used herein means that the coating or other packaging is substantially devoid of fluorocarbons to thereby have no fluorocarbons or only minute traces of fluorocarbons. Preferably, the interior volume of the package 20 will be filled with food 35, for instance unpopped popcorn kernels, and the food 35 will be enclosed within the package 20. FIGS. 4, 5, and 6 illustrate various stages in the assembly of an embodiment of the high temperature package 20 shown in FIG. 1. When assembled, the package 20, for example, can include a front panel 21, a back panel 22 opposing the front panel 21, a bottom panel 26, and a pair of opposing side panels 23, 24 each extending between the front panel 21 and the back panel 22. The pair of opposing side panels 23, 24 each includes first and second side panel portions 23a, 23b and 24a and 24b, respectively joined along fold lines 23c and 24c, respectively. Side panels 23, 24 are folded inwardly along a longitudinal accordion pleat that defines longitudinal gusseted folds in the panels. Adhesive strip 31 on the bottom panel 26 of the package holds the bottom panel 26 end of the bag together when the front panel 21, back panel 22, and side panels 23, 24 are folded upon one another and pressed together. The front panel 21, the back panel 22, and the bottom panel 26 form a tube body. The interior volume of the tube body is filled with food 35 and an oil or grease material 36 and then closed. The gusseted side panels 23, 24 are expandable about the folds therein during cooking of food 35 so that the interior volume of the package 20 containing food 35 and oil or grease material 36 enlarges during cooking such as shown in FIG. 1. It will be understood by those skilled in the art, however, that many other high temperature foods, e.g., tacos, burritos, french fries, fried pork rinds, and various fast foods, and many other shapes, sizes, and types of packages can be used as well according to the present invention.

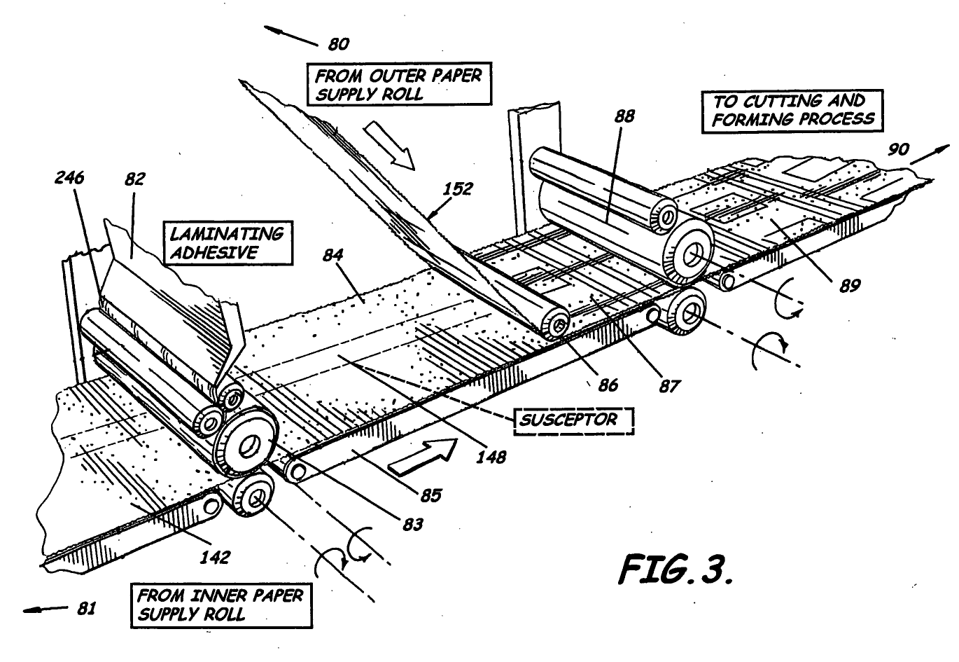

The packaging material of the high temperature package 20, for example, can be multiply and can preferably include, as illustrated in FIG. 2B, at least one outer substrate 252 formed of a paper material and having an inner surface 251 and an outer surface 253. The package 20 also can have at least one inner substrate 242 formed of a paper material, and an outer surface 243 of inner substrate 242 laminated to the inner surface 251 of the outer substrate 252 so that the combination of the at least one outer substrate 252 and the at least one inner substrate 242 define a laminated substrate 21, e.g., prior to shaping or further forming the package 20 (see FIG. 3).

In an alternate embodiment as illustrated in FIG. 2D, the grease resistant coating 454 can be positioned on an outer surface 453 of the outer substrate 452 and on an inner surface 441 of the inner substrate 442. The package 420 can further have another starch-based coating 411 positioned on an inner surface 451 of the outer substrate 452 and the other starch-based coating 410 on an outer surface 443 of the inner substrate 442. Coatings 410, 411, for example, can have a preselected chemistry associated therewith to promote adhesive qualities as understood by those skilled in the art, in addition to the grease resistant qualities. Thus, coatings of varying chemistries can be positioned in a variety of locations on substrates, for example, on the outer surface 453 of the outer substrate 452 and the inner surface 451 of the outer substrate 452, as well as on the outer surface 443 of the inner substrate 442 and on the inner surface 441 of the inner substrate 442.

The coating such as shown in FIGS. 2A-2C preferably includes a starch-based film having a pre-selected percent by weight of at least one pre-selected starch derivative, a flexibility enhancing agent, a rheological agent, and a scorch resistant agent. The at least one starch derivative preferably is a chemically modified starch. The flexibility enhancing agent is preferably selected from a group consisting of a monomer diluent, a flexible polymer, and combinations thereof. The monomer diluent is preferably selected from the group consisting of glycols, water, glucose, sucrose, oligosaccharides, and combinations thereof, and the flexible polymer is preferably selected from the group consisting of ethyl cellulose, carboxymethyl cellulose, derivatized polysaccharides, and combinations thereof. The Theological agent is preferably selected from a group consisting of a solvent and a dispersant. The solvent is preferably selected from the group consisting of glycols, water, glucose, sucrose, oligosaccharides, and combinations thereof, and the dispersant is preferably selected from the group consisting of linear high molecular weight polysaccharides, ethoxylated saccharides, and combinations thereof. The scorch resistant agent is preferably selected from the group consisting of glycol, a sucrose derivative, and phosphates of sugars, and combinations thereof. The coating also is preferably substantially free of protein.

Examples of starch-based films can be found in U.S. Pat. No. 6,528,088 titled “Highly Flexible Starch-Based Films” (“the '088 patent”) and U.S. Pat. No. 6,375,981 titled “Modified Starch As A Replacement For Gelatin In Soft Gel Films And Capsules” (“the '981 patent”), both by Gillenland et al., and both of which are incorporated herein in their entirety. As understood by those skilled in the art, the starch-based films described in the '088 patent and the '981 patent can be utilized as a starting point, and modified as discussed herein by including a flexibility enhancing agent preferably selected from the group as described herein, a rheological agent preferably selected from the group as described above, and a scorch resistant agent preferably selected from the group as described above, to make and use the starch-based derivative coating devoid of fluorocarbons as described herein.

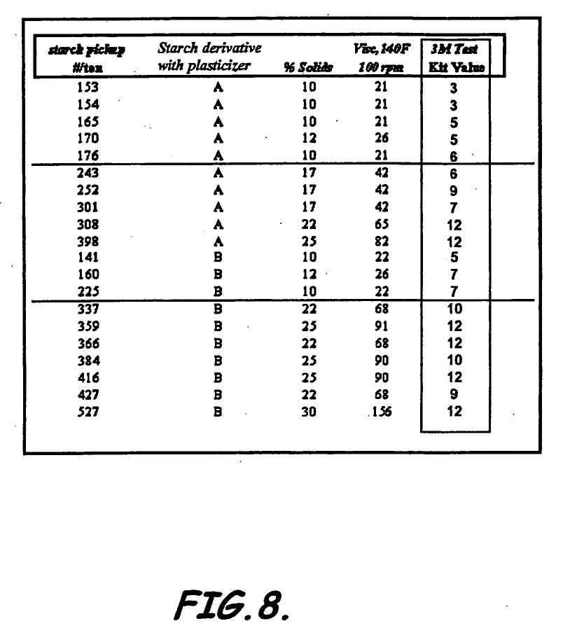

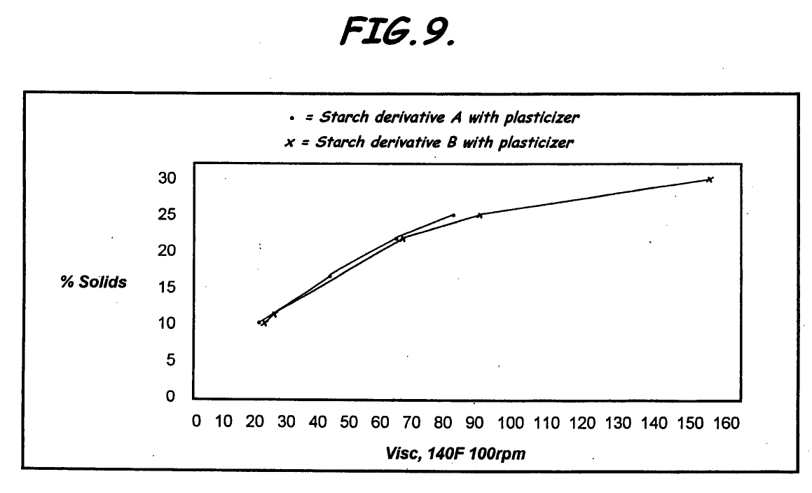

FIG. 8 is a table illustrating the effect of increasing a total amount of solids in a starch material on the elasticity of the starch. Starch derivatives A and B are successive generations or derivations of the starch material. Elasticity is indicated by an increase in the viscosity of the starch solution. As illustrated, when starch is used as an extender, viscosity can increase as the percentage of solids in the starch material increases. This is also shown in the graph of FIG. 9. Additionally, even when viscosity does not increase, starch pickup in pounds per ton and oil and grease resistance, as measured by 3M Kit test results, can increase.

Based on the information from these studies conducted by Applicants, Applicants were able to determine that a starch-based derivative coating can be developed by adding a flexibility enhancing agent and a rheological agent and yet be substantially gel free. Applicants recognized that the existing starch-based derivative can have higher gelling qualities as the concentration of solids is increased. The coating preferably includes a composition having a solids concentration by weight of about 10% to about 35%, more preferably about 20% to about 25%, and is substantially free from a gel formation. The coating preferably has a viscosity in a range of about 65 centipoise to about 156 centipoise. The starch-based material preferably includes a cornstarch. Applicants also recognized that coating inner and outer surfaces of each of the inner and outer substrates can prevent grease, or increase grease holdout, such as generated during cooking or microwave heating of food within a package, from or around a small puncture, fracture, tear, or other opening in the inner substrate from passing through to the outer substrate where staining of the outer substrate would be more readily viewable by the user.

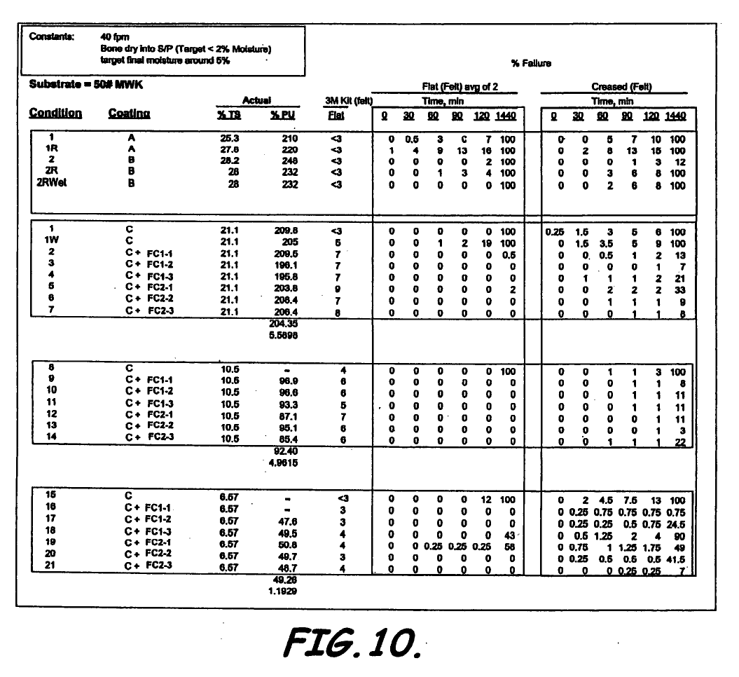

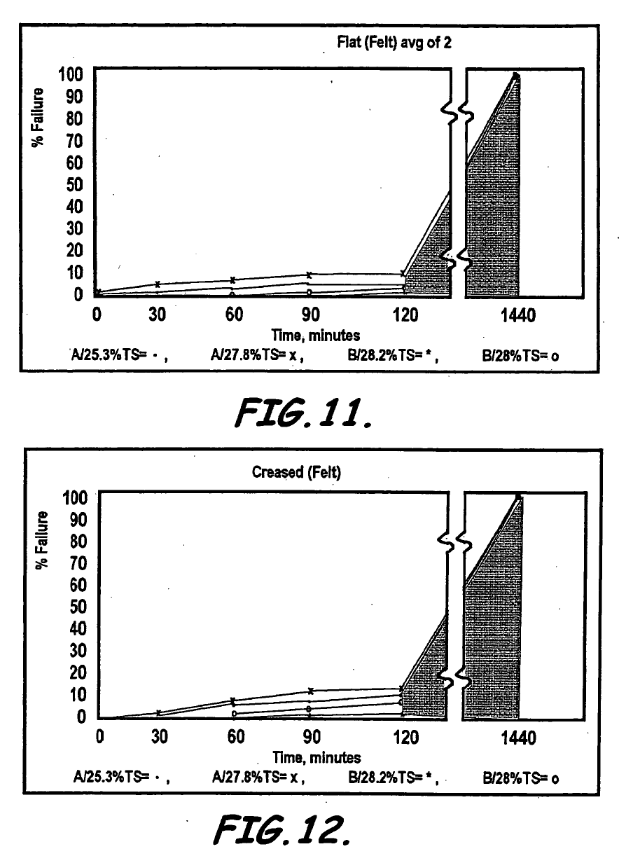

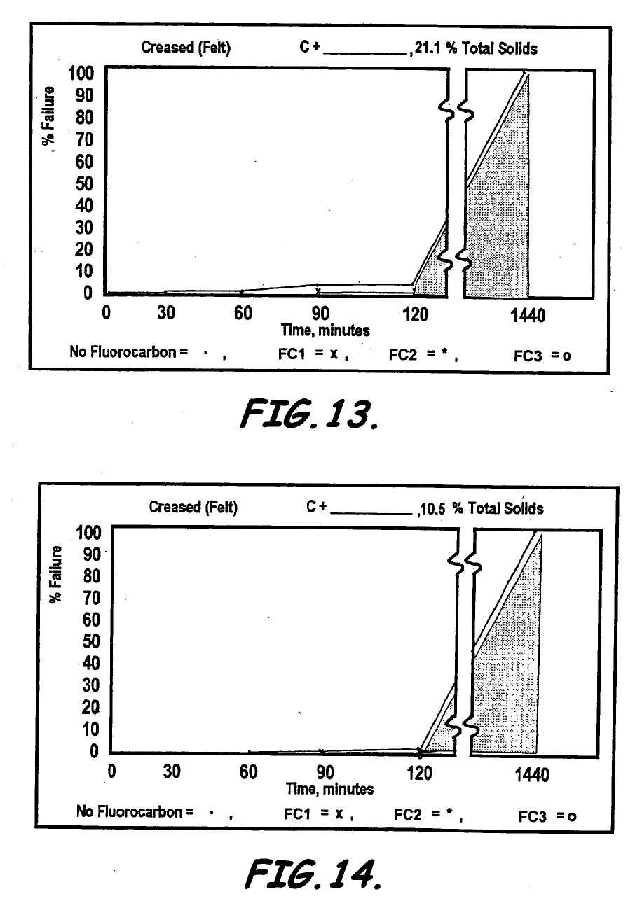

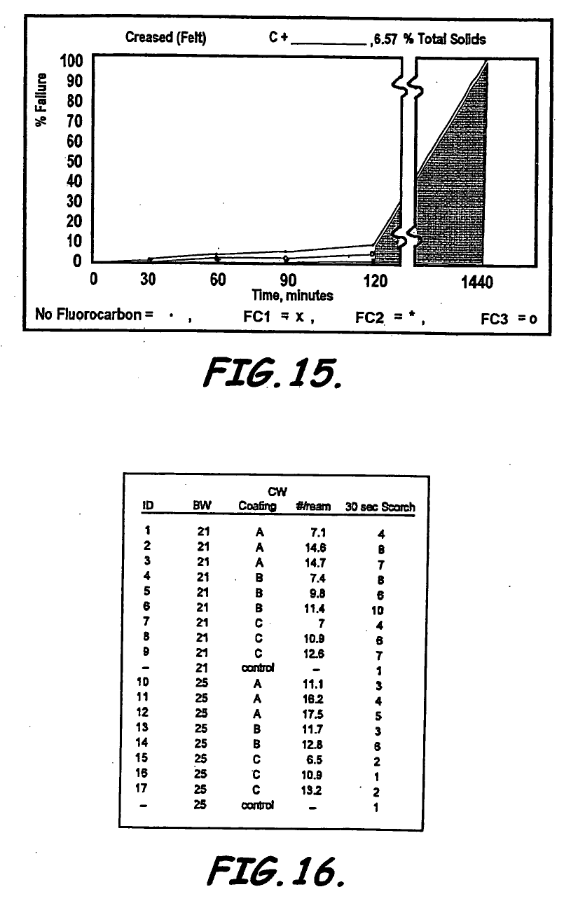

The table of FIG. 10 illustrates results of a kit test (felt) and RP2, flat and creased, over time in minutes with different percent total solids (“% TS”) by weight, e.g., 6.57%, 10.5%, 21.1%, and 25.3% to 28%. From this data, it can be seen that roughly 100 failures occur after a 24 hour (1440 minutes) period. Nevertheless, up to about 90 minutes or 120 minutes, a starch-based coating having no fluorocarbons closely tracks coatings using a starch-based derivative as a fluorocarbon extender. This significant increase in failure for the 24 hour period as compared to the 2 hour period is shown by the shaded region of the graphs in FIGS. 11-15. This dramatic change and failure of starch-based derivatives as fluourcarbon extenders helped Applicants recognize that a starch-based derivative coating devoid of fluorocarbons can be produced that will significantly decrease the failure rate over time by adding a flexibility enhancing agent and a Theological agent.

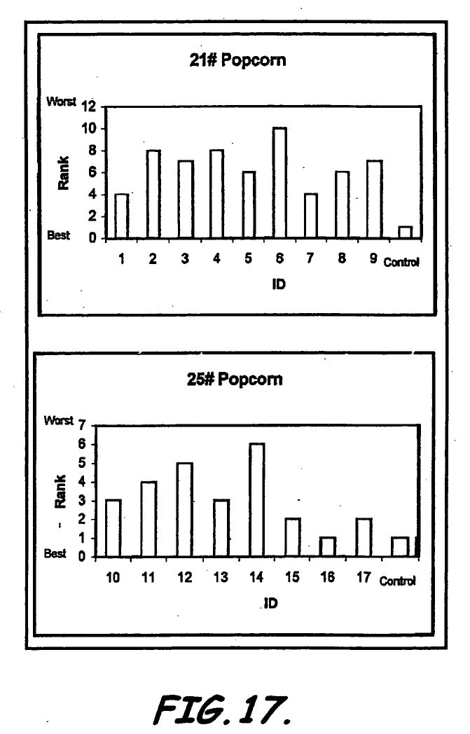

FIG. 16 is a table illustrating the results of a scorch resistance test for various coatings on two different grades of packaging paper, i.e., 21# popcorn grade and 25# popcorn grade. These results are also graphically illustrated in FIG. 17. Applicants recognized that the addition of a scorch resistant agent can significantly reduce the occurrence of browning when a starch-based derivative is used by itself as a coating.

The packaging 20 may also further include a susceptor adhesive 150, as illustrated in FIG. 2A, positioned on the coating 145 of the inner surface 151 of the outer substrate 152, a high temperature susceptor 148 positioned on the susceptor adhesive 150 and positioned between the susceptor adhesive 150 and the coating 144 on the outer surface 143 of the inner substrate 142, and a laminating adhesive 146 positioned on the susceptor 148 and the inner surface 151 of the outer substrate 152 and contacting the coating 144 on the outer surface 143 of the inner substrate 142. As understood by those skilled in the art, the susceptor 148 is a device which generates auxiliary heat upon exposure to microwave energy.

Alternatively, the packaging 320 may also include, as illustrated in FIG. 2C, the outer substrate 352 and the inner substrate 342 each having the coating thereon. The coating 354 on the outer substrate 352 is positioned on an outer surface 353 of the outer substrate 352, and the coating 340 on the inner substrate 342 is positioned on an inner surface 341 of the inner substrate 342. The package 320 further has a grease resistant laminating adhesive 300 positioned between an inner surface 351 of the outer substrate 352 and an outer surface 343 of the inner substrate 342. The grease resistant laminating adhesive 300 serves as an additional protective layer to prevent oil or grease leakage if, for example, the coating 340 on the inner substrate 342 fails to provide adequate protection, or else if microscopic holes in the inner substrate 342 or outer substrate 352 allow oil or grease to pass through. The oil or grease could potentially reach the outer layer of coating 354 of the packaging and cause leakage or unsightly discoloration.

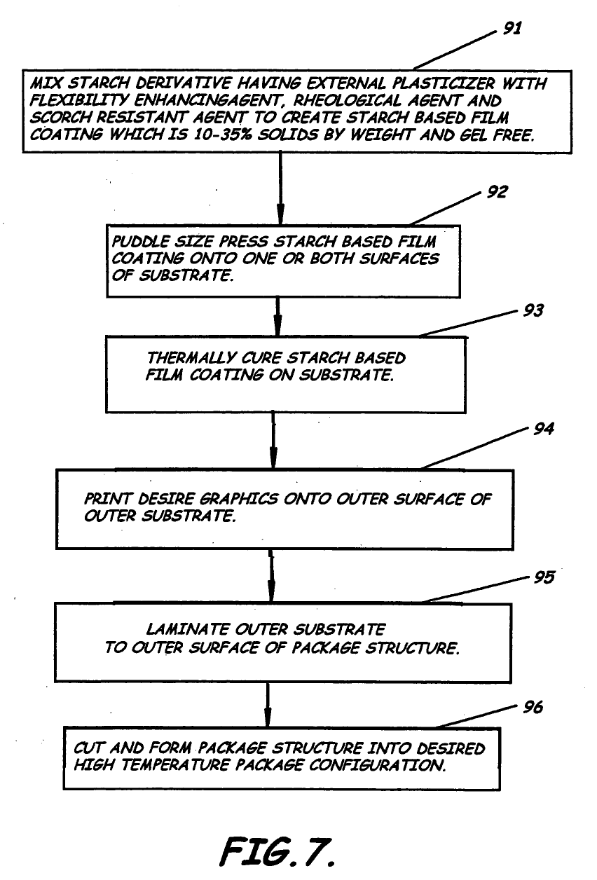

As illustrated in FIGS. 1-17, and as described herein, methods of forming a non-fluorocarbon treated high temperature package having oil and grease resistant properties are also included according to embodiments of the present invention. For example, such a method is illustrated in the block diagram of FIG. 7. As shown in first block 91, the method preferably includes supplying at least one outer substrate 152 comprising a paper material having a grease resistant coating 154 devoid of fluorocarbons thereon. The coating 154 preferably is a starch-based film including a pre-selected percent by weight of at least one pre-selected starch derivative, a flexibility enhancing agent, a Theological agent, and a scorch resistant agent. The at least one starch derivative preferably is a chemically modified starch. Second block 92 and third block 93 generally show the steps of supplying a substrate 152 having a coating 154 thereon including the step of applying the coating 154 to one or both surfaces 151, 153 of the substrate 152. The coating 154 is applied using an application method selected from the group consisting of a puddle size press, a meter size press, blade coating, roll coating, rod coating, and rotogravure. The coating 154 is then thermally cured on substrate 152. The fourth block 94 shows the printing of indicia on an outer surface 153 of the at least one outer substrate 152. The fifth block 95 shows laminating with laminating adhesive 146 the at least one outer substrate 152 having indicia thereon to the at least one inner substrate 142. The substrate 152 is then shaped as desired, as shown in block 96, to define, for example, a front panel 21, a back panel 22 opposing the front panel 21, and a pair of opposing side panels 23, 24 each extending between the front panel 21 and the back panel 22, the pair of opposing side panels 23, 24 each having a longitudinal accordion pleat therein defining longitudinal gusseted folds in the panels 23, 24, the pair of gusseted side panels 23, 24 being expandable about the folds therein during cooking of food 35 in the package 20 to enlarge an interior volume of the package 20.

FIG. 3 shows an embodiment of a process for high temperature bag-making according to the present invention. Packaging materials for constructing package 20 are passed along a conveyer belt 85 and are married to one another by a laminating process as understood by those skilled in the art to form a non-fluorocarbon treated high temperature package 20 having oil and grease resistant properties. For example, laminating adhesive applicator 82 supplies laminating adhesive 246 to be applied to inner substrate 142 from a supply roll 81 at press roll 83. After passing press roll 83, the exposed laminated surface of resulting material 84 is contacted with outer substrate 152 with indicia printed thereon from the supply roll 80 at a press roll 86. As would be understood by those skilled in the art, outer substrate 152 and inner substrate 142 can be of equal sizes, but typically inner substrate is equal to or smaller than outer substrate 152, because inner substrate 142 is more likely to be reduced in size as a cost-saving measure by manufacturers. After passing the press roll 86, a resulting material 87 is contacted with an additional press roll 88 to further marry the resulting material 87. Upon passing the press roll 88, resulting material or laminated substrate 89 moves to cutting and forming equipment 90 to form the finished package 20 as understood by those skilled in the art (see also, FIGS. 4-6).

In the drawings and specification, there have been disclosed typical preferred embodiments of the invention and, although specific terms are employed, they are used in a generic and descriptive sense only and not for the purpose of limitation, the scope of the invention being set forth in the following claims.

1. A method of forming a non-fluorocarbon treated high temperature package having oil and grease resistant properties, the method comprising the steps of:
supplying at least one outer substrate comprising a paper material having a grease resistant coating devoid of fluorocarbons thereon, the coating comprising a starch-based film comprising a pre-selected percent by weight of at least one pre-selected starch derivative, a flexibility enhancing agent, a rheological agent, and a scorch resistant agent, the at least one starch derivative comprising a chemically modified starch;
supplying at least one inner substrate comprising a paper material also having the grease resistant coating thereon;
printing indicia on an outer surface of the at least one outer substrate;
laminating the at least one outer substrate having indicia thereon to the at least one inner substrate to define a laminated substrate; and
shaping the laminated substrate to define a front panel, a back panel opposing the front panel, and a pair of opposing side panels each extending between the front panel and the back panel, the pair of opposing side panels each having a longitudinal accordion pleat therein defining longitudinal gusseted folds in the panels, the pair of gusseted side panels being expandable about folds therein during cooking of food in the package to enlarge an interior volume of the package.

2. A method as defined in claim 1, wherein the coating on the outer substrate is positioned on the outer surface of the outer substrate and the inner surface of the outer substrate, and wherein the coating on the inner substrate is positioned on the outer surface of the inner substrate and on the inner surface of the inner substrate.

3. A method as defined in claim 2, further comprising the step of:
supplying a high temperature susceptor;
applying susceptor adhesive to the inner surface of the outer substrate;
applying the susceptor to the susceptor adhesive; and
wherein the laminating step includes applying a laminating adhesive to the susceptor and to the inner surface of the outer substrate, and positioning the outer surface of the inner substrate on the laminating adhesive.

4. A method as defined in claim 1, wherein the coating on the outer substrate is positioned on the outer surface of the outer substrate, wherein the coating on the inner substrate is positioned on the inner surface of the inner substrate, and wherein the laminating step includes applying a grease resistant laminating adhesive to an inner surface of the outer substrate and positioning an outer surface of the inner substrate on the grease resistance laminating adhesive.

5. A method as defined in claim 1, further comprising supplying the coating in a composition having a solids concentration by weight of about 10% to about 35%, and wherein the coating is substantially free from a gel formation.

6. A method as defined in claim 5, wherein the coating has a viscosity in a range of about 65 centipoises to about 156 centipoises, and wherein the coating has a solids concentration by weight of about 20% to about 25%.

7. A method as defined in claim 6, wherein the flexibility enhancing agent is selected from a group consisting of a monomer diluent and a flexible polymer.

8. A method as defined in claim 7, wherein the monomer diluent is selected from the group consisting of glycols, water, glucose, sucrose, oligosaccharides, and combinations thereof and the flexible polymer is selected from the group consisting of ethyl cellulose, carboxymethyl cellulose, ethoxylated cellulose, and derivatized polysaccharides, and combinations thereof.

9. A method as defined in claim 6, wherein the Theological agent is selected from a group consisting of a solvent, a dispersant, and combinations thereof, the scorch resistant agent is preferably selected from the group consisting of glycol, a sucrose derivative, phosphates of sugars, and combinations thereof.

10. A method as defined in claim 9, wherein the solvent is selected from the group consisting of glycols, water, glucose, sucrose, oligosaccharides, and combinations thereof and the dispersant is selected from the group consisting of linear high molecular weight polysaccharides, ethoxylated saccharides, and combinations thereof.

11. A method as defined in claim 10, wherein the coating is substantially free of protein, wherein the starch material comprises at least cornstarch.

12. A method as defined in claim 1, wherein each of the steps of supplying a substrate having a coating thereon includes the step of applying the coating to the substrate by utilizing an application method selected from the group consisting of a puddle size press, a meter size press, blade coating, roll coating, rod coating, and rotogravure.

13. A method as defined in claim 1, further including filling the interior volume of the package with the food, positioning an oil material in the package, and enclosing the food and oil material within the package.

14. A method of forming a non-fluorocarbon treated high temperature package having oil and grease resistant properties and having contents therein, the method comprising the steps of:
supplying at least one outer substrate comprising a paper material having a grease resistant coating devoid of fluorocarbons thereon, the coating comprising a starch-based derivative, a flexibility enhancing agent and a rheological agent;
supplying at least one inner substrate comprising a paper material also having the coating thereon;
laminating the at least one outer substrate to the at least one inner substrate; and
shaping the substrate to define a preselected package shape.

15. A method as defined in claim 14, wherein the coating on the outer substrate is positioned on the outer surface of the outer substrate and the inner surface of the outer substrate, and wherein the coating on the inner substrate is positioned on the outer surface of the inner substrate and on the inner surface of the inner substrate.

16. A method as defined in claim 15, further comprising supplying a high temperature susceptor, applying susceptor adhesive to the inner surface of the outer substrate, applying the susceptor to the susceptor adhesive, and wherein the laminating step includes applying a laminating adhesive to the susceptor and to the inner surface of the outer substrate, and positioning the outer surface of the inner substrate on the laminating adhesive.

17. A method as defined in claim 14, wherein the coating on the outer substrate is positioned on the outer surface of the outer substrate, wherein the coating on the inner substrate is positioned on the inner surface of the inner substrate, and wherein the laminating step includes applying a grease resistant laminating adhesive to an inner surface of the outer substrate, and positioning an outer surface of the inner substrate on the grease resistance laminating adhesive.

18. A method as defined in claim 14, further comprising supplying the coating in a composition having a solids concentration by weight of about 10% to about 35%, and wherein the coating is substantially free from a gel formation and includes a scorch resistant agent.

19. A method as defined in claim 18, wherein the coating has a viscosity in a range of about 65 centipoises to about 156 centipoises, and wherein the coating further has a solids concentration by weight of about 20% to about 25%.

20. A method as defined in claim 19, wherein the flexibility enhancing agent is selected from a group consisting of a monomer diluent and a flexible polymer.

21. A method as defined in claim 20, wherein the monomer diluent is selected from the group consisting of glycols, water, glucose, sucrose, oligosaccharides, and combinations thereof, and the flexible polymer is selected from the group consisting of ethyl cellulose, carboxymethyl cellulose, ethoxylated cellulose, derivatized polysaccharides, and combinations thereof.

22. A method as defined in claim 19, wherein the rheological agent is selected from a group consisting of a solvent and a dispersant.

23. A method as defined in claim 22, wherein the solvent is selected from the group consisting of glycols, water, glucose, sucrose, oligosaccharides, and combinations thereof and the dispersant is selected from the group consisting of linear high molecular weight polysaccharides, ethoxylated saccharides, and combinations thereof.

24. A method as defined in claim 14, wherein each of the steps of supplying a substrate having a coating thereon includes the step of applying the coating to the substrate by utilizing an application method selected from the group consisting of a puddle size press, a meter size press, blade coating, roll coating, rod coating, and rotogravure.

25. A method as defined in claim 14, further including filling an interior volume of the package having the preselected package shape with the food, positioning an oil material in the package, and enclosing the food and oil material within the package.

26. A non-fluorocarbon treated high temperature package having oil and grease resistant properties comprising:
at least one substrate comprising a paper material, the substrate defining a front panel, a back panel opposing the front panel, a bottom panel, and a pair of opposing side panels each extending between the front panel and the back panel, the pair of opposing side panels each having a longitudinal accordion pleat therein defining longitudinal gusseted folds in the panels, the pair of gusseted side panels being expandable about folds therein during cooking of food in the package to enlarge an interior volume of the package, the front panel, the back panel, and the bottom panel form a tube body; and
a coating positioned on both an inner surface and an outer surface of the tube body, the coating comprising a starch-based film comprising a pre-selected percent by weight of at least one pre-selected starch derivative, a flexibility enhancing agent, a rheological agent, and a scorch resistant agent, the at least one starch derivative comprising a chemically modified starch.

27. A package as defined in claim 26, wherein the at least one substrate comprises an outer substrate and an inner substrate each having the coating thereon, wherein the coating on the outer substrate is positioned on an outer surface of the outer substrate and an inner surface of the outer substrate, and wherein the coating on the inner substrate is positioned on the outer surface of the inner substrate and on the inner surface of the inner substrate.

28. A package as defined in claim 27, further comprising a susceptor adhesive positioned on the coating of the inner surface of the outer substrate, a high temperature susceptor positioned on the susceptor adhesive and positioned between the susceptor adhesive and the coating on the outer surface of the inner substrate, and a laminating adhesive positioned on the susceptor and the inner surface of the outer substrate and contacting the coating on the outer surface of the inner substrate.

29. A package as defined in claim 26, wherein the at least one substrate comprises an outer substrate and an inner substrate each having the coating thereon, wherein the coating on the outer substrate is positioned on an outer surface of the outer substrate, wherein the coating on the inner substrate is positioned on an inner surface of the inner substrate, and wherein the package further comprising a grease resistant laminating adhesive positioned between an inner surface of the outer substrate and an outer surface of the inner substrate.

30. A package as defined in claim 26, wherein the flexibility enhancing agent is selected from a group consisting of a monomer diluent and a flexible polymer.

31. A package as defined in claim 30, wherein the monomer diluent is selected from the group consisting of glycols, water, glucose, sucrose, oligosaccharides, and combinations thereof, and the flexible polymer is selected from the group consisting of ethyl cellulose, carboxymethyl cellulose, ethoxylated cellulose, derivatized polysaccharides, and combinations thereof.

32. A package as defined in claim 26, wherein the rheological agent is selected from a group consisting of a solvent and a dispersant.

33. A package as defined in claim 32, wherein the solvent is selected from the group consisting of glycols, water, glucose, sucrose and oligosaccharides, and the dispersant is selected from the group consisting of linear high molecular weight polysaccharides, and ethoxylated saccharides.

34. A package as defined in claim 33, wherein the coating comprises a composition having a solids concentration by weight of about 10% to about 35%, and wherein the coating is substantially free from a gel formation and is substantially protein free.

35. A package as defined in claim 34, wherein the coating has a viscosity in a range of about 65 centipoise to about 156 centipoise, wherein the coating further has a solids concentration by weight of about 20% to about 25%, and wherein the package comprises a front panel, a back panel opposing the front panel, a bottom panel, and a pair of opposing side panels each extending between the front panel and the back panel, the pair of opposing side panels each having a longitudinal accordion pleat therein defining longitudinal gusseted folds in the panels, the pair of gusseted side panels being expandable about folds therein during cooking of food in the package to enlarge an interior volume of the package, the front panel, the back panel, and the bottom panel forming a tube body.

36. A package as defined in claim 35, wherein the starch material comprises a cornstarch.

37. A non-fluorocarbon treated high temperature package having oil and grease resistant properties comprising:
at least one outer substrate having an inner surface and an outer surface and comprising a paper material;
at least one inner substrate comprising a paper material and having an outer surface thereof laminated to the inner surface of the outer substrate so that the combination of the at least one outer substrate and the at least one inner substrate define a laminated substrate, the laminated substrate further having a front panel, a back panel opposing the front panel, a bottom panel, and a pair of opposing side panels each extending between the front panel and the back panel, the pair of opposing side panels each having a longitudinal accordion pleat therein defining longitudinal gusseted folds in the panels, the pair of gusseted side panels being expandable about folds therein during cooking of food in the package to enlarge an interior volume of the package, the front panel, the back panel, and the bottom panel forming a tube body; and
a coating positioned on both an inner surface and an outer surface of the tube body, the coating comprising a starch-based film comprising a pre-selected percent by weight of at least one pre-selected starch derivative, a flexibility enhancing agent, a rheological agent, and a scorch resistant agent, the at least one starch derivative comprising a chemically modified starch.

38. A package as defined in claim 37, wherein the coating on the outer surface of the tube body comprises the coating being positioned on an outer surface of the outer substrate, wherein the coating on an inner surface of the tube body comprises the coating being positioned on an inner surface of the inner substrate, and the package further having the coating positioned on an inner surface of the outer substrate and on an outer surface of the inner substrate.

39. A package as defined in claim 38, further comprising a susceptor adhesive positioned on the coating of the inner surface of the outer substrate, a high temperature susceptor positioned on the susceptor adhesive and positioned between the susceptor adhesive and the coating on the outer surface of the inner substrate, and a laminating adhesive positioned on the susceptor and the inner surface of the outer substrate and contacting the coating on the outer surface of the inner substrate.

40. A package as defined in claim 37, the outer substrate and the inner substrate each having the coating thereon, wherein the coating on the outer substrate is positioned on an outer surface of the outer substrate, wherein the coating on the inner substrate is positioned on an inner surface of the inner substrate, and the package further comprises a grease resistant laminating adhesive positioned between an inner surface of the outer substrate and an outer surface of the inner substrate.

41. A package as defined in claim 37, wherein the flexibility enhancing agent is selected from a group consisting of a monomer diluent and a flexible polymer.

42. A package as defined in claim 41, wherein the monomer diluent is selected from the group consisting of glycols, water, glucose, sucrose and oligosaccharides, and the flexible polymer is selected from the group consisting of ethyl cellulose, carboxymethyl cellulose, ethoxylated cellulose, derivatized polysaccharides, and combinations thereof.

43. A package as defined in claim 38, wherein the Theological agent is selected from a group consisting of a solvent, a dispersant, and combinations thereof.

44. A package as defined in claim 43, wherein the solvent is selected from the group consisting of glycols, water, glucose, sucrose, oligosaccharides, and combinations thereof, and the dispersant is selected from the group consisting of linear high molecular weight polysaccharides, ethoxylated saccharides, and combinations thereof, and wherein the coating is substantially free of protein.

45. A package as defined in claim 37, wherein the coating comprises a composition having a solids concentration by weight of about 10% to about 35%, and wherein the coating is substantially free from a gel formation.

46. A package as defined in claim 45, wherein the coating has a viscosity in a range of about 65 centipoise to about 156 centipoise, and wherein the coating further has a solids concentration by weight of about 20% to about 25%.

47. A package as defined in claim 46, wherein the starch material comprises a cornstarch.
